(19) United States
(12) Patent Application Publication
(10) Pub. No.: US 2026/0120011 A1
(43) Pub. Date: Apr. 30, 2026

(54) METHODS AND SYSTEM TO PREDICT UNDERSTAFFED TERMINALS FOR LABOR OPTIMIZATION AND MANAGEMENT

(71) Applicant: NCR Voyix Corporation, Atlanta, GA (US)

(72) Inventors: Anael Miryam Engel, Yodfat (IL); Shiran Abadi, Tel-Aviv (IL)

(21) Appl. No.: 18/933,222

(22) Filed: Oct. 31, 2024

(51) Int. Cl. G06Q 10/0631

(52) U.S. Cl. CPC G06Q 10/06311

(57) ABSTRACT

Methods and a system for determining understaffed periods in retail stores leverages self-checkout (SCO) usage patterns and machine learning. The methods and system select stores with medium to high SCO adoption rates, identifies “busy” hours based on SCO and point-of-sale (POS) idle times, and trains a classification machine learning model using various transactional features. This model then predicts understaffed hours for all stores, including those without SCOs. The methods and system provide real-time alerts and reports, enabling retailers to make informed staffing decisions, improve customer satisfaction, and optimize labor costs. By analyzing existing transactional data, the methods and system offer a novel approach to staffing management in modern retail environments.

### BACKGROUND

Labor hours planning is a crucial factor for store performance, as it directly impacts customer satisfaction and revenue. Accurately determining staffing levels based on store traffic and transactional data presents a significant challenge for retailers. Traditional methods of estimating staffing needs often rely on manual observations or simplistic analysis of transaction logs, which can lead to inaccurate assessments of whether a store is adequately staffed, understaffed, or overstaffed at any given time. These imprecise methods can result in suboptimal labor allocation, potentially leading to long customer wait times during busy periods or unnecessary labor costs during slower periods. Furthermore, the increasing complexity of modern retail environments, with multiple checkout options and varying customer preferences, adds another layer of difficulty to the staffing puzzle.

### BRIEF DESCRIPTION OF THE DRAWINGS

FIG. 1 is a diagram of a system for predicting and identifying understaffed terminals for labor optimization and management, according to an example embodiment.

FIG. 2 is a flow diagram of a method for predicting and identifying understaffed terminals for labor optimization and management, according to an example embodiment.

FIG. 3 is a flow diagram of another method for predicting and identifying understaffed terminals for labor optimization and management, according to an example embodiment.

### DETAILED DESCRIPTION

Labor hours planning is a crucial factor for store performance, as it directly affects customer satisfaction and revenue. To adequately plan staff scheduling, it is beneficial to understand past data and learn from it the relationship between traffic (items sold per hour, for example) and the recommended number of cashiers, both Point-of-Sales (POS) and attendants of Self-Checkout lanes (SCO), if those are available in the store. However, determining whether an hour was understaffed, overstaffed, or adequately staffed without direct information from the store owner that could label each hour is difficult.

Understanding staffing levels from transactional data, which retailers typically have access to, is not trivial. Current methods of estimating staffing levels using transactional data alone can be inaccurate and do not realistically portray the actual status of the store. For example, transactional data may indicate that there were 4 cashiers working at the casher-assisted point-of-sale (POS) terminal and one of them was free 90% of the time, which could mean that the store was overstaffed at this time. But in practice, the fourth cashier might be a picker in the store that came to assist at the POS terminal to free a bottleneck because it was understaffed. Similarly, the transactional data may indicate that there were 2 occupied cashiers that worked 70% of the shift, which could be interpreted as if the store were understaffed. But in reality, there might have been a third cashier that was sent to take another role because two cashiers were enough to handle the traffic-and the store was actually overstaffed. Accordingly, retailers need more sophisticated tools to analyze their operational data and make informed staffing decisions that balance customer service quality with operational efficiency.

In an embodiment presented herein, a novel machine learning model (MLM) is proposed to evaluate whether an hour was understaffed using commerce data. This approach leverages the increasingly common usage of self-checkout (SCO) lanes and terminals in retail stores to detect such cases. The determination is done according to the stores that own SCO lanes but is also generalized to all stores in the chain, even those that have only cashier-assisted POS lanes or terminals.

Experimentation has shown that at times in which the front-end POS terminals are understaffed, shoppers in stores with SCO terminals will tend to use the SCO terminals even if they normally prefer the cashiers on POS terminals. In such cases, SCO terminals will be at its maximal capacity when the store is poorly staffed. The approach involves a multi-step analysis process: first, finding stores with good SCO adoption rates and usage, then identifying hours in which these sampled stores with SCO terminals can be labeled as “busy”—when customers turned to the SCO terminals because the front-end cashiers were understaffed. Finally, this “busy” label is used in a classification model with many measures and not dependent on SCO terminals being present in any given store-to expand the criteria to stores with and without SCO terminals to find other measures of the store that can be used to define “busy” hours.

The approaches herein enable the detection of understaffed periods in real time, running every 15 minutes or at any preconfigured interval to send alerts or update dashboards. This helps retailers identify understaffing issues and make informed staffing decisions, ultimately improving customer satisfaction and optimizing labor costs. By analyzing existing transactional data and SCO usage patterns, this approach offers a sophisticated solution to staffing management in modern retail environments, addressing the complexities that traditional approaches struggle to handle.

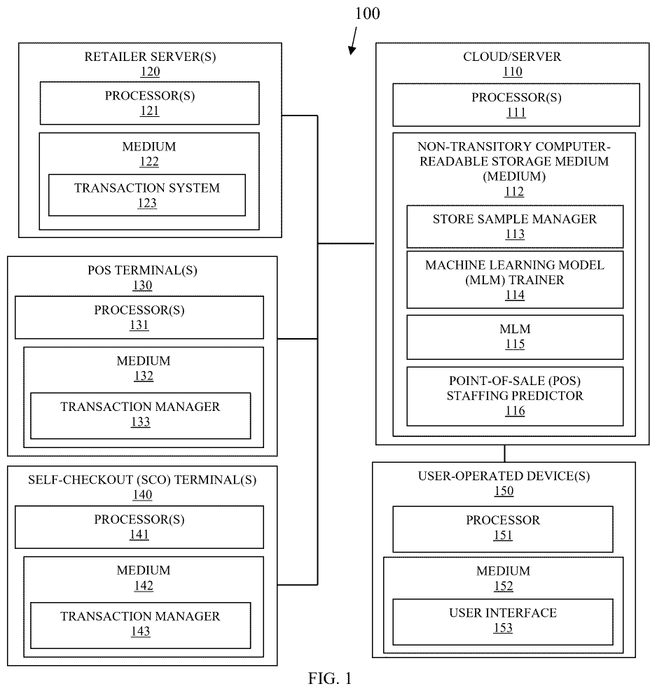

FIG. 1 is a diagram of a system 100 for predicting and identifying understaffed terminals for labor optimization and management, according to an example embodiment. Notably, the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of predicting and identifying understaffed terminals for labor optimization and management, presented herein and below.

System 100 includes a cloud 110 or server, one or more retailer servers 120, one or more POS terminals 130, one or more SCO terminals 140, and one or more user-operated devices 150. Cloud 110 includes at least one processor 111 and a non-transitory computer-readable storage medium 112 (medium), which includes instructions for a an a store sample manager 113, a MLM trainer 114, a MLM 115, and a POS staffing predictor 116. The instructions when executed by the processor 111 cause the processor 111 to perform operations discussed herein and below with respect to 113-115.

Each retail server 120 includes at least one processor 121 and a medium 122, which includes instructions for a transaction system 123.

The instructions when executed by the processor 121 cause the processor 121 to perform the operations discussed herein and below with respect to transaction system 123.

Each POS terminal 130 includes at least one processor 131 and a medium 132, which includes instructions for a transaction manager 133. The instructions when executed by the processor 131 cause the processor 131 to perform the operations discussed herein and below with respect to transaction manager 133.

Each SCO terminal 140 includes at least one processor 141 and a medium 142, which includes instructions for a transaction manager 143. The instructions when executed by the processor 141 cause the processor 141 to perform the operations discussed herein and below with respect to transaction manager 143.

Each user-operated device 150 includes at least one processor 151 and a medium 152, which includes instructions for a user interface (UI) 153. The instructions when executed by the processor 151 cause the processor 151 to perform operations discussed herein and below with respect to UI 153.

Initially, store sample manager 113 collects a variety of transaction data from stores that include SCO terminals 140 and POS terminals 130. The store sample manager 113 selects the stores, which have medium to high SCO terminal adoption rates.

In an embodiment, the medium and high adoption rates can be set by predetermined range. For each store selected, the store sample manager 113 calculates a ratio for a total number of SCO transactions on SCO terminals 140 relative to a total number of POS transaction on POS terminals 130. In an embodiment, the store sample manager 113 calculates each store's ratio as the total number of SCO transactions relative to the total number of transactions on both the SCO terminals 140 and the POS terminals. The store sample manager 113 compares each store's ratio against the predetermined range and selects stores that fall within the predetermined range.

In an embodiment, the store sample manager 113 uses criteria that avoids selecting stores in which SCO terminals 140 are not regularly used by customers. For example, SCO terminals 140 in a given store often malfunction, are purposefully disabled, or an assistant is not normally assigned to SCO terminals to assist customers in case of needed intervention.

Experimentation has revealed that low staffing levels at POS terminals 130 in the selected stores correlate to a situation where customers are more likely to increase their usage of available SCO terminals 140. To determine these situations in the selected stores, store sample manager 113 identifies, from corresponding transaction data of the selected stores, times of high SCO usage or times when SCO terminals 140 can be classified as being “busy” or busier than what would typically be expected.

Next, store sample manager finds hours of transaction data for the selected stores in which the SCO terminals 140 can be labeled as being “busy” such that customers of the selected stores turned to using the SCO terminals 140 because cashiers at POS terminals 130 of the selected stores were likely understaffed. In order to find the times when the selected and sampled stores are busy, store sample manager 113 considers when POS idle time is low (e.g., percentage of time of cashier sign-on time, in which the cashiers are not processing transactions, such as due to bagging time, accepting the next customer, etc.). Cashier idle time only can be misleading such that an assumption cannot be made based on POS idle time alone whether or not a store was busy or not at the POS terminals 130. Due to the situations discussed above. As a result, store sample manager 113 also considers when a store reaches a minimum POS idle time of approximately 30% or less, and idle time on the SCO terminals was less than or equal to 40%.

Based on this analysis, store sample manager 113 labels the time intervals for each selected store as being “busy” or “non-busy.” MLM trainer 114 generalizes the criteria used to label the time intervals as “busy” or “non-busy” to detect busy and non-busy time intervals regardless as to whether a given store includes or does not include any SCO terminals 140. MLM trainer 114 extracts features from the labeled transaction data provided by the store sample manager 113 such that the extracted features are non-related to SCO terminals 140 for purposes of training MLM 115 on the labeled transaction data and the extracted features.

MLM trainer 114 extracts a first feature as POS idle time, which is the time that a cashier does not process transactions out of the total sign-on duration. Idle time is considered as the time between consecutive customers. Low POS idle time indicates that cashiers has short times between transactions thus POS terminals 130 are likely understaffed and busy.

However, low POS idle time is not a conclusive feature nor conclusive evidence of a store being understaffed, as traffic at the store must also be high relative to the number of available cashiers. Accordingly, MLM trainer 114 extracts and/or calculates additional features from the labeled transaction data of the sampled and selected stores. In an embodiment, these additional features include a total number of item line counts (e.g., a total number of items sold during the interval of time at each store), a completed ticket count (e.g., a total number of transactions or tickets completed in the interval of time at each store), an hour of the day associated with the interval of time at each store, a sum of all POS cashiers'sign-on durations over the hour, a total ticket duration (e.g., sum of transaction durations over the hour or interval of time), a total number of transactions divided by the total number of touchpoints or POS terminals 130 (e.g., this normalizes to the total number of working cashiers at the POS terminals 130), and a total number of items sold divided by a total POS sign-on duration (e.g., a load on cashiers operating the POS terminals 130).

MLM trainer 114 uses the features as input to MLM 115 during a training session along with the labeled “busy” and “non-busy” classification provided by the store sample manager 113. In an embodiment, output provided by the MLM is a binary classification of either “busy” or “non-busy,” which is reflective on the staffing level at the POS terminals 130 at a given store relative to the store's traffic.

In an embodiment, the MLM 115 finds optimal features to rely on for making a POS staffing level prediction using feature selection methods and thresholds by using analysis, clustering on selected features, or impurity techniques. For example, the MLM is implemented as a decision tree with a Gini index. Experimentation with the decision tree with Gini index revealed that POS idle time should be approximately 30% or lower, the total number of items sold per POS sign-on duration should be higher than 300 items per working hour, and the total number of transactions should be larger than 5 per hour. This illustrates low idle time, high item throughput per cashier at the POS terminals 130, and the number of transactions is not redundant.

Once MLM trainer 114 verifies acceptable accuracy metrics for MLM 115, MLM is released for providing real-time predictions of any given store's POS staffing. At any given store, cashiers operate POS terminals 130 to perform transactions processed by transaction manager 133. Transaction manager 133 provides transaction data to a corresponding transaction system 123 or directly to POS staffing predictor 116. In a case, where the transaction data is provided to transaction system 123, POS staffing predictor 116 obtains the transaction data from the transaction system 123. Next, POS staffing predictor 116 extracts and calculates the features, which are agnostic to transactions processed on any available SCO terminals 140 by transaction manager 143 as was discussed above.

POS staffing predictor 116 provides the features as input to the MLM for each interval of time and the MLM 115 returns as output a predicted staffing level assessment for the POS terminals 130 during that interval of time. POS staffing predictor 116 uses an application programming interface (API) to interact with interface 153 and presents an indication as to whether the POS terminals for the interval of time is properly staffed or insufficient staffed. In an embodiment, the interface 153 also interacts with POS staffing predictor 116 to obtain customized graphical visualizations of proper POS staffing and insufficient POS staffing over the intervals for a given period of time.

System 100 reduces customer labor in trying to identify proper POS terminal staffing. Even a modest or nominal improvement in identifying understaffed POS terminals 130 can save hundreds of thousands of dollars recovered annually by retailers. System 100 provides identification of understaffed POS terminals 130 for stores in near real-time, within a few minutes after an interval of time passes. This allows the retailer to adjust staffing for the remainder of the day.

In an embodiment, system 100 provides understaffed or properly staffed indications to stores in as little as 15 minute intervals throughout a business day. In an embodiment, POS staffing predictor 116 is provides as software-as-a-service to existing store and retailer systems or services. For example, POS staffing predictor 116 usings an API to provide continuous throughout the day staffing indications within a dashboard of an existing store or retailer system or service.

In an embodiment of system 100 where a given store has customers that, by in large, prefer to use the SCO terminals 140 but the SCOs are busy, an hour is designated as and/or determined to be “busy” when both the POS terminals 130 and SCO terminals 140 are busy. This can be done by comparing usage or idle times at the SCO terminals 140 and POS terminals 130 to one or more thresholds.

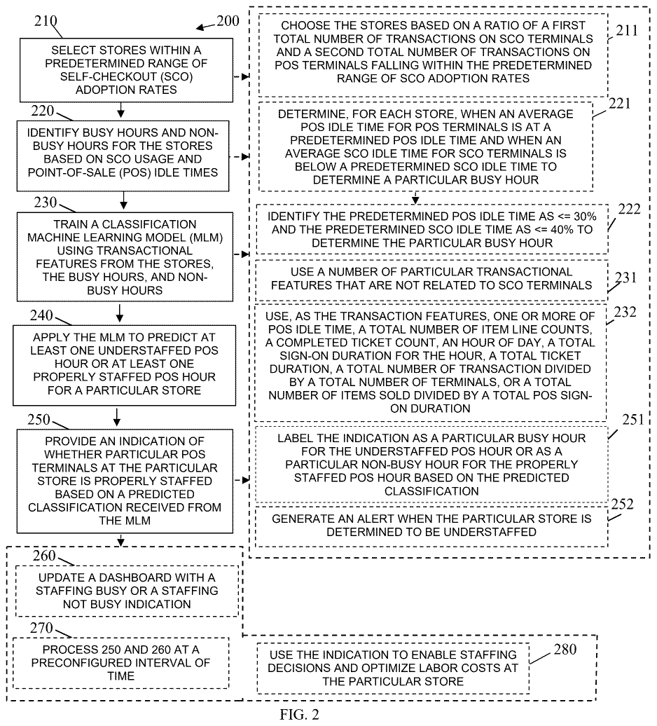

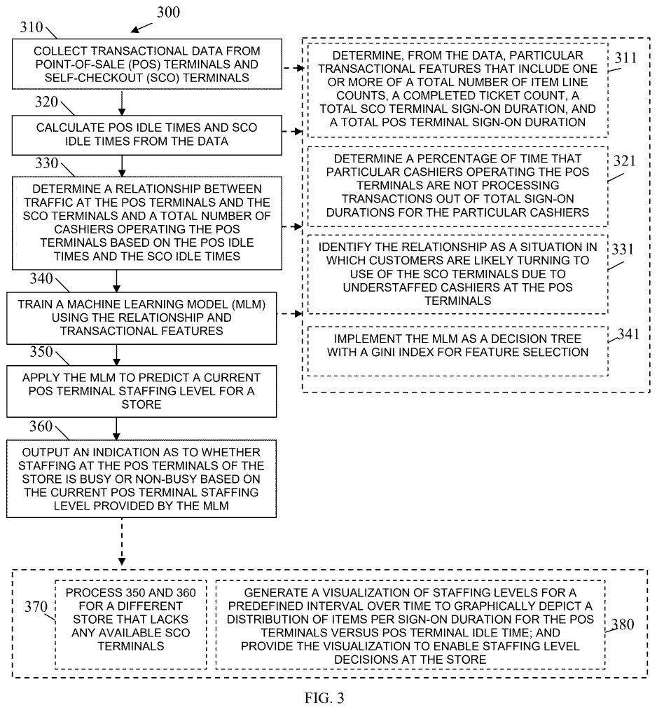

The above-referenced embodiments and other embodiments are now discussed within FIGS. 2-3. FIG. 2 is a flow diagram of a method 200 for predicting and identifying understaffed terminals for labor optimization and management, according to an example embodiment. The software module(s) that implements the method 200 is referred to as a “terminal staffing manager.” The terminal staffing manager is implemented as executable instructions programmed and residing within memory and/or a non-transitory computer-readable (processor-readable) storage medium and executed by one or more processors of one or more devices. The processor(s) of the device that executes the terminal staffing manager are specifically configured and programmed to process the terminal staffing manager. The terminal staffing manager may have access to one or more network connections during its processing. The network connections can be wired, wireless, or a combination of wired and wireless.

In an embodiment, the device that executes the terminal staffing manager is cloud 110. In an embodiment, the device that execute the terminal staffing manager is retailer server 120. In an embodiment, the terminal staffing manager is all or some combination of store sample manager 113, MLM trainer 114, MLM 115, and/or POS staffing predictor 116.

At 210, the terminal staffing manager selects stores within a predetermined range of SCO adoption rates from a plurality of stores. The stores can be for a single retailer chain or span across multiple different retailer chains. In an embodiment, at 211, the terminal staffing manager choses the stores based on a ratio of a first number of transaction on SCO terminals 140 and a second total number of transactions on POS terminals 130 falling within the predetermined range of SCO adoption rates.

At 220, the terminal staffing manager identifies busy hours and non-busy hours for stores based on SCO usage and POS idle times. In an embodiment, at 221, the terminal staffing manager determines, for each store, when an average POS idle time for POS terminals 130 is at a predetermined POS idle time and when an average SCO idle time for SCO terminals 140 is below a predetermined SCO idle item to determine a particular busy hour. In an embodiment, of 221 and at 222, the terminal staffing manager identifies the predetermined POS idle time as less than or equal to approximately 30% and identifies the predetermined SCO idle time as less than or equal to 40% to determine the particular busy hour.

At 230, the terminal staffing manager trains a classification MLM 115 using transactional features from the stores, the busy hours, and the non-busy hours. In an embodiment, at 231, the terminal staffing manager uses a number of particular transactional features that are not related to SCO terminals 140 or not uses each of the transactional features which are not related to SCO terminals 140. In an embodiment, at 232, the terminal staffing manager uses, as the transactional features, one or more of POS idle time, a total number of item line counts, a completed ticket count, an our of day, a total sign-on duration for the hour, a total ticket duration, a total number of transactions divided by a total number of POS terminals 130, and/or a total number of items sold divided by a total POS sign-on duration.

At 240, the terminal staffing manager, applies the MLM 115 to predict at least one understaffed POS hour or at least one properly staffed POS hour for a particular store. At 250, the terminal staffing manager provides an indication of whether particular POS terminals 130 at the particular store is properly staffed based on a predicted classification received from the MLM 115.

In an embodiment, at 251, the terminal staffing manager labels the indication as a particular busy hour for the understaffed POS hour or as a particular non-busy hour for the properly staffed POS hour based on the predicted classification. In an embodiment, at 252, the terminal staffing manager generates and sends an alert when the particular store is determined to be understaffed.

In an embodiment, at 260, the terminal staffing manager updates a dashboard with a staffing busy or a staffing not busy indication based on the predicted classification. In an embodiment, at 270, the terminal staffing manager processes 250 and 260 at a preconfigured interval of time. In an embodiment, at 280, the terminal staffing manager uses the indication to enable staffing decisions and optimize labor costs at the particular store by integrating the indication into an existing system or service of the store or a retailer associated with the store.

FIG. 3 is a diagram of another method 300 for predicting and identifying understaffed terminals for labor optimization and management, according to an example embodiment. The software module(s) that implements the method 300 is referred to as a “terminal staffing level analyzer.” The terminal staffing level analyzer is implemented as executable instructions programmed and residing within memory and/or a non-transitory computer-readable (processor-readable) storage medium and executed by one or more processors of a device. The processors that execute the terminal staffing level analyzer are specifically configured and programmed for processing the terminal staffing level analyzer. The terminal staffing level analyzer may have access to one or more network connections during its processing. The network connections can be wired, wireless, or a combination of wired and wireless.

In an embodiment, the device that executes the terminal staffing level analyzer is cloud 110. In an embodiment, the device that executes the terminal staffing level analyzer is retailer server 120. In an embodiment, the terminal staffing level analyzer is all or some combination of store sample manager 113, MLM trainer 114, MLM 115, POS predictor 116, and/or method 200 of FIG. 2. The terminal staffing level analyzer presents another, and in some ways an enhanced processing perspective from that which was described above with method 200 of FIG. 2.

At 310, the terminal staffing level analyzer collects transaction data from POS terminals 130 and SCO terminals 140. In an embodiment, at 311, the terminal staffing level analyzer determines, from the transactional data, particular transactional features that include one or more of a total number of item line counts, a completed ticket count, a total SCO terminal sign-on duration, and a total POS terminal duration.

At 320, the terminal staffing level analyzer calculates POS idle times and SCO idle times from the transactional data. In an embodiment, at 321, the terminal staffing level analyzer determines a percentage of time that particular cashiers operating the POS terminals 130 are not processing transactions out of total sign-on durations for the particular cashiers.

At 330, the terminal staffing level analyzer determines a relationship between traffic at the POS terminals 130 and the SCO terminals 140 and a total number of cashiers operating the POS terminals 130 based on the POS idle times and the SCO idle times. In an embodiment, at 331, the terminal staffing level analyzer identifies the relationship as a situation in which customers are likely turning to use of the SCO terminals 140 due to understaffed cashiers operating the POS terminals 130.

At 340, the terminal staffing level analyzer trains a MLM 115 using the relationship and transactional features extracted and calculated from the transactional data. In an embodiment, the MLM 115 is implemented as a decision tree with a Gini index for feature selection.

At 350, the terminal staffing level analyzer applies the MLM 115 to predict a current POS terminal staffing level for a store. At 360, the terminal staffing level analyzer outputs an indication as to whether staffing at the POS terminals 130 of the store is busy or non-busy based on the current POS terminal staffing level provided by the MLM 115.

In an embodiment, at 370, the terminal staffing level analyzer processes 350 and 360 for a different store that lacks any available SCO terminals 140. In an embodiment, at 380, the terminal staffing level analyzer generates a visualization of staffing levels for a predefined interval over time to graphically depict a distribution of times per sign-on duration for the POS terminals 130 versus POS idle time. The terminal staffing level analyzer provides the visualization via UI 153 to enable staffing level decisions at the store.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
selecting stores withing a predetermined range of self-checkout (SCO) adoption rates;
identifying busy hours and non-busy hours for the stores based on SCO usage and point-of-sale (POS) idle times;
training a classification machine learning model (MLM) using transactional features from the stores, the busy hours, and the non-busy hours;
applying the classification MLM to predict at least one understaffed POS hour or at least one properly staffed POS hour for a particular store; and
providing an indication of whether particular POS terminals at the particular store is properly staffed based on a predicted classification received from the classification MLM.

2. The method of claim 1, wherein selecting further comprises choosing the stores based on a ratio of a first total number of transactions on SCO terminals for the stores and a second total number of transactions on POS terminals for the stores falling within the predetermined range of SCO adoption rates.

3. The method of claim 1, wherein identifying further comprises determining, for each store, when an average POS idle time for POS terminals is at a predetermined POS idle time and when an average SCO idle time for SCO terminals is below a predetermined SCO idle time to determine a particular busy hour.

4. The method of claim 3, wherein determining further comprises identifying the predetermined POS idle time as approximately 30% and identifying the predetermined SCO idle time less that or equal to 40% to determine the particular busy hour.

5. The method of claim 1, wherein training further comprises using a number of particular transactional features that are not related to SCO terminals.

6. The method of claim 1, wherein training further comprises using, as the transactional features, one or more of POS idle time, a total number of item line counts, a completed ticket count, an hour of day, a total sign-on duration for the hour, a total ticket duration, a total number of transactions divided by a total number of terminals, or a total number of items sold divided by a total POS sign-on duration.

7. The method of claim 1, wherein providing further comprises labeling the indication as a particular busy hour for the at least one understaffed POS hour or labeling the indication as a particular non-busy hour for the at least one properly staffed POS hour based on the predicted classification.

8. The method of claim 1, wherein providing further comprises generating an alert when the particular store is determined to be understaffed.

9. The method of claim 1, further comprising:
updating a dashboard with a staffing busy or a staffing not busy indication.

10. The method of claim 1, further comprising:
processing the applying and the providing at a preconfigured interface of time to provide real-time staffing indications.

11. The method of claim 1, further comprising:
using the indication to enable staffing decisions and optimize labor costs at the particular store.

12. A method, comprising:
collecting transactional data from point-of-sale (POS) terminals and self-checkout (SCO) terminals;
calculating POS idle times and SCO idle times from the transactional data;
determining a relationship between traffic at the POS terminals and the SCO terminals and a total number of cashiers operating the POS terminals based on the POS idle times and the SCO idle times;
training a machine learning model (MLM) using the relationship and transactional features;
applying the MLM to predict a current POS terminal staffing level for a store; and
outputting an indication as to whether staffing at the POS terminals of the store is busy or non-busy based on the current POS terminal staffing level provided by the MLM.

13. The method of claim 12, wherein collecting further comprises determining, from the transactional data, particular transactional features that comprise one or more of a total number of item line counts, a completed ticket count, a total SCO terminal sign-on duration, and a total POS terminal sign-on duration.

14. The method of claim 12, wherein calculating further comprises determining a percentage of time that particular cashiers operating the POS terminals are not processing transactions out of total sign-on durations for the particular cashiers.

15. The method of claim 12, wherein determining further comprises identifying the relationship as a situation in which customers are likely turning to use the SCO terminals due to understaffed cashiers at the POS terminals.

16. The method of claim 12, wherein training further comprises implementing the MLM as a decision tree with a Gini index for feature selection.

17. The method of claim 12, further comprising:
processing the applying and the outputting for a different store that lacks any available SCO terminals.

18. The method of claim 12, further comprising:
generating a visualization of staffing levels for a predefined interval over time to graphically depict a distribution of items per sign-on duration for the POS terminals versus POS terminal idle time; and
providing the visualization to enable staffing level decisions at the store.

19. A system, comprising:
a processor;
a non-transitory computer-readable storage medium comprising instructions;
the instructions when executed by the processor cause the processor to perform operations comprising:
collecting transactional data from point-of-sale (POS) terminals and self-checkout (SCO) terminals;
calculating POS terminal idle times and SCO terminal idle times from the transactional data;
determining a relationship between terminal transaction traffic and a total number of cashiers operating the POS terminals based on the POS terminal idle times and the SCO terminal idle times;
training a machine learning model (MLM) using the relationship and transactional features;
applying the MLM to predict staffing levels for one or more stores; and
provide one or more indications of a proper staffing level or an improper staffing level to the one or more stores based on one or more predicted staffing levels provided by the MLM.

20. The system of claim 19, wherein the operations further comprise:
determining a particular hour to be “busy” when usage at both the SCO terminals and the POS terminals are above one or more thresholds.
